(19) United States
(12) Patent Application Publication
(10) Pub. No.: US 2014/0324839 A1
(43) Pub. Date: Oct. 30, 2014

(54) DETERMINING CANDIDATE SCRIPTS FROM A CATALOG OF SCRIPTS

(71) Applicant: HEWLETT-PACKARD DEVELOPMENT COMPANY, L.P., Houston, TX (US)

(72) Inventors: Craig Peter SAYERS, Menlo Park, CA (US); Alkiviadis Simitsis, Santa Clara, CA (US); Georgia Koutrika, Palo Alto, CA (US)

(73) Assignee: Hewlett-Packard Development Company, L.P., Houston, TX (US)

(21) Appl. No.: 13/874,235

(22) Filed: Apr. 30, 2013

(51) Int. Cl. G06F 17/30

(52) U.S. Cl. CPC G06F 17/30386
USPC 707/723

(57) ABSTRACT

According to an example, candidate scripts may be determined from a catalog of scripts to perform a requested operation. In determining the candidate scripts, a request for an operation may be received, in which the request includes an input and an output. In addition, based upon the input and the output, a plurality of candidate scripts that are to perform the requested operation may be identified from the catalog of scripts, in which each of the plurality of candidate scripts comprises at least one of a script that is to perform the requested operation individually or a number of scripts that, in combination, are to perform the requested operation. Moreover, a score for each of plurality of candidate scripts may be calculated based upon a plurality of factors respectively corresponding to the plurality of candidate scripts and the plurality of candidate scripts and the calculated scores may be outputted.

### BACKGROUND

Programming large systems, such as big data systems, is relatively complex and thus often requires developers that have requisite skills to program such systems. For instance, many developers would like to perform big-data analytics using Map/reduce engines such as Hadoop® or parallel database engines such as Vertica™, which is available from the HP Vertica of Cambridge, Mass. However, many of the developers lack the necessary expert skills to perform such big-data analytics. To ease the task for developers, scripting languages such as “Pig”, which is a high-level platform for creating map-reduce programs, are being developed. These scripting languages are often automatically optimized and compiled to run either as a series of map-reduce operations on Hadoop®, or as complex SQL expressions on Vertica™.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of a computing apparatus, which may implement various features disclosed herein, according to an example of the present disclosure;

FIG. 2 depicts a simplified block diagram of a network environment including the computing apparatus depicted in FIG. 1, according to an example of the present disclosure;

FIG. 3 depicts a flow diagram of a method for determining candidate scripts from a catalog of scripts to perform a requested operation, according to an example of the present disclosure;

FIG. 4 depicts a flow diagram of a method for determining candidate scripts from a catalog of scripts to perform a requested operation, according to another example of the present disclosure;

FIG. 5 depicts a simplified example of an output of a plurality of candidate scripts and calculated scores, according to an example of the present disclosure; and

FIG. 6 illustrates a schematic representation of an electronic device, which may be employed to perform various functions of the computing apparatus depicted in FIGS. 1 and 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are methods and computing apparatuses for determining candidate scripts from a catalog of scripts to perform a requested operation. Particularly, the methods and computing apparatuses disclosed herein may automatically identify candidate scripts that may include individual scripts and/or combinations of scripts that may perform the requested operation. In addition, the methods and computing apparatuses disclosed herein may calculate scores for each of the identified candidate scripts based upon a plurality of factors that respectively correspond to the candidate scripts. According to an example, users may assign different weights to the factors, which may vary the scores, thus enabling users with the ability to identify which of the identified candidate scripts best meets their criteria.

According to an example, through implementation of the methods and apparatuses disclosed herein, a user may simply submit a request for an operation, in which the request includes an input and an output, and the user may be provided with candidate scripts that are able to perform the operation. In addition, the candidate scripts may be displayed in a ranked order based upon the scores calculated for each of the candidate scripts. The user may determine which of the candidate scripts to use to perform the requested operation based upon the ranked order of the candidate scripts. In one regard, the determination of the candidate scripts that may perform the requested operation may be relatively simpler than requiring users to either code the script themselves or to search through a plurality of scripts for the appropriate scripts themselves.

Users may thus discover and run scripts (e.g., services) on their own data without writing code. As such, users may be able to program large systems without having the ability to write the code associated with programming the large systems. The large systems may be big data systems, which may be defined systems that include a collection of data sets that are so large and complex that it becomes difficult and/or inefficient to process using traditional data processing applications.

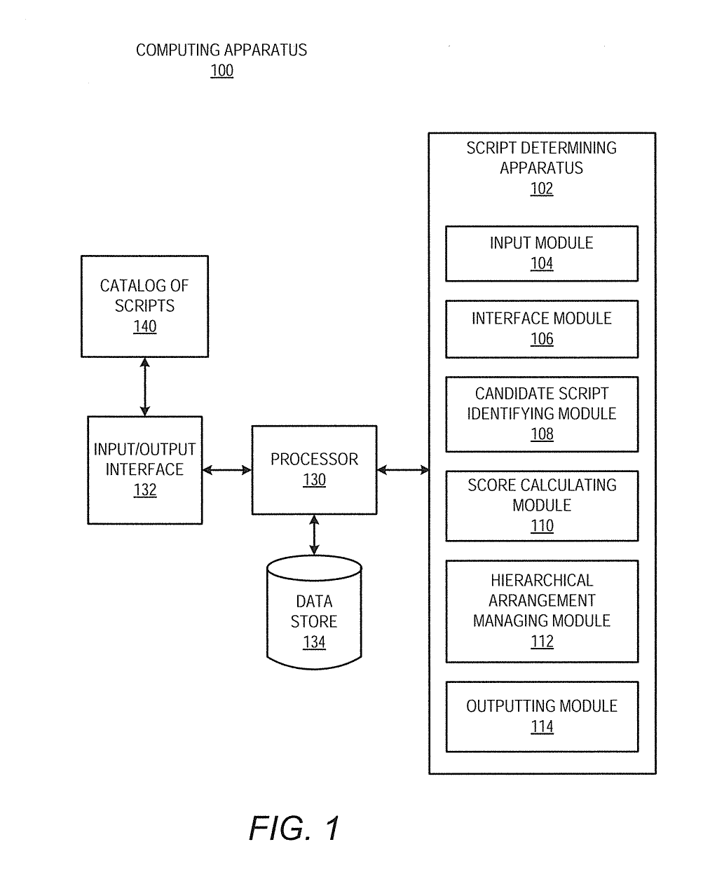

With reference first to FIG. 1, there is shown a simplified block diagram of a computing apparatus 100, which may implement various features disclosed herein, according to an example. It should be understood that the computing apparatus 100 may include additional elements and that some of the elements depicted therein may be removed and/or modified without departing from a scope of the computing apparatus 100.

Generally speaking, the computing apparatus 100 may be a desktop computer, a server, a laptop computer, a tablet computer, etc., at which a catalog of scripts may be managed as discussed in greater detail herein. The computing apparatus 100 is depicted as including a script determining apparatus 102, a processor 130, an input/output interface 132, a data store 134, and a catalog of scripts 140. The script determining apparatus 102 is also depicted as including an input module 104, an interface module 106, a candidate script identifying module 108, a score calculating module 110, a hierarchical arrangement managing module 112, and an outputting module 114.

The processor 130, which may be a microprocessor, a micro-controller, an application specific integrated circuit (ASIC), and the like, is to perform various processing functions in the computing apparatus 100. One of the processing functions may include invoking or implementing the modules 104-114 of the script determining apparatus 102 as discussed in greater detail herein below. According to an example, the script determining apparatus 102 is a hardware device, such as, a circuit or multiple circuits arranged on a board. In this example, the modules 104-114 may be circuit components or individual circuits.

According to another example, the script determining apparatus 102 is a hardware device, for instance, a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like, on which software may be stored. In this example, the modules 104-114 may be software modules stored in the script determining apparatus 102. According to a further example, the modules 104-114 may be a combination of hardware and software modules.

The processor 130 may store data in the data store 134 and may use the data in implementing the modules 104-114. The data store 134 may be volatile and/or non-volatile memory, such as DRAM, EEPROM, MRAM, phase change RAM (PCRAM), Memristor, flash memory, and the like. In addition, or alternatively, the data store 134 may be a device that may read from and write to a removable media, such as, a floppy disk, a CD-ROM, a DVD-ROM, or other optical or magnetic media.

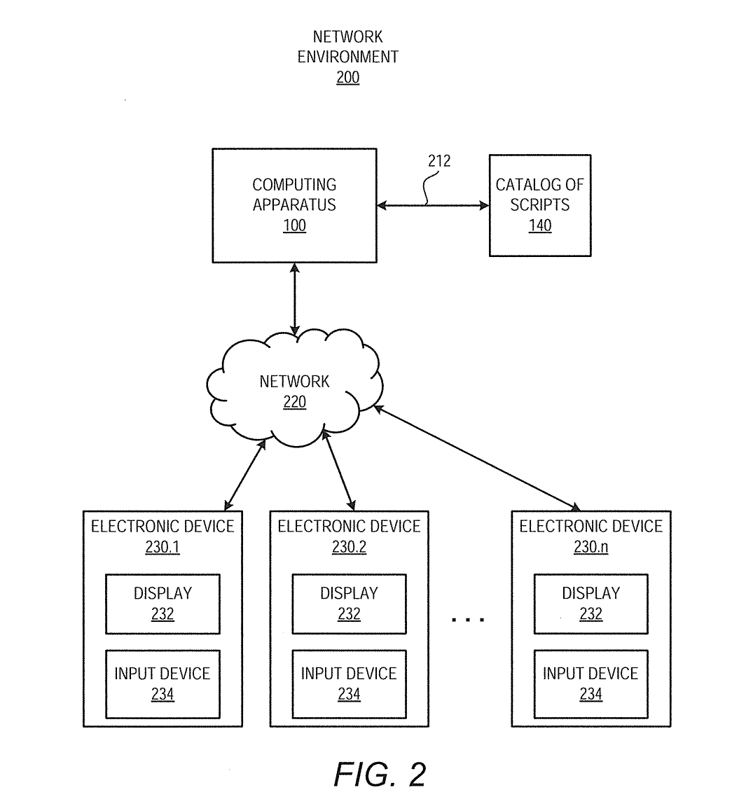

The input/output interface 132 may include hardware and/or software to enable the processor 130 to communicate with the catalog of scripts 140 as well as an externally located electronic device (shown in FIG. 2). According to an example, the catalog of scripts 140 is stored in a memory of the computing apparatus 100, for instance, in the data store 134. In another example, the catalog of scripts 140 is stored in a memory that is external to and connected directly to the computing apparatus 100, such as through a USB interface or other interface. In a yet further example, the catalog of scripts 140 is stored in a memory that is external to and connected via a network connection to the computing apparatus 100. In this example, the catalog of scripts 140 may be stored in a server, a database, etc., and the input/output interface 132 may include hardware and/or software to enable the processor 130 to communicate over a network, such as the Internet, a local area network, a wide area network, a cellular network, etc., to the catalog of scripts 140.

Generally speaking, the catalog of scripts 140 is a searchable and interactive script catalog. In addition, the computing apparatus 100 may execute the scripts contained in the catalog of scripts. The scripts may be, for instance, scripts for performing analytics over big data using map-reduce engines. As discussed in greater detail herein below, developers may add new scripts into the catalog of scripts 140 and may use the shared knowledge of other community members when developing new scripts, which may also be added into the catalog of scripts 140. In addition, each script, such as a Pig script, added to the catalog of scripts 140 becomes an executable service, with inputs and outputs defined by relation schemas. Those services may be discoverable through use of natural language searches and may be composable using, for instance, a drag-and-drop interface, which may be provided to the users by the computing apparatus 100. In one regard, through implementation of the script determining apparatus 102 disclosed herein, a user may discover services that are able to perform selected operations on their own the data without writing code to perform those operations.

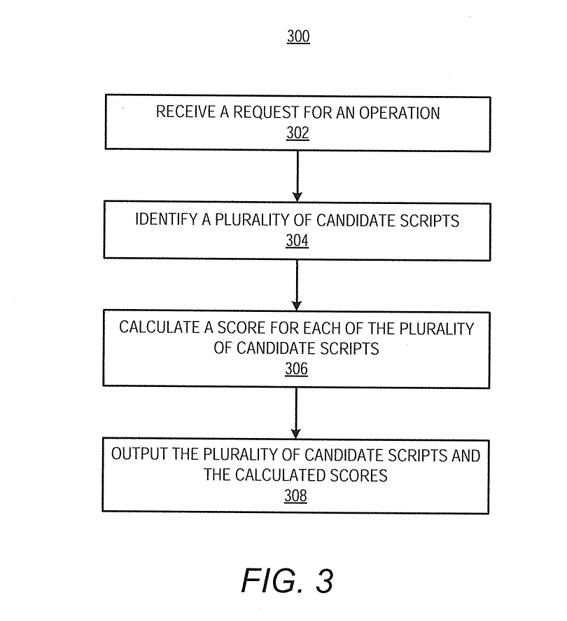

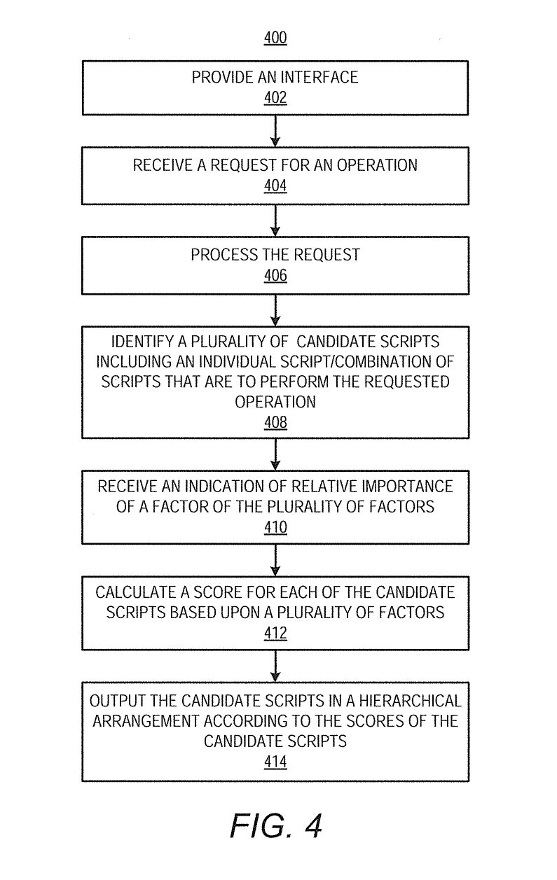

Various manners in which the script determining apparatus 102 in general and the modules 104-114 in particular may be implemented are discussed in greater detail with respect to the methods 300 and 400 depicted in FIGS. 3 and 4. Prior to discussion of the methods 300 and 400, however, reference is made to FIG. 2, in which is shown a simplified block diagram of a network environment 200 including the computing apparatus 100 depicted in FIG. 1, according to an example. It should be understood that the network environment 200 may include additional elements and that some of the elements depicted therein may be removed and/or modified without departing from a scope of the network environment 200.

The computing apparatus 100 may be in communication with the catalog of scripts 140 in any of the manners discussed above. As such, the catalog of scripts 140 may be stored in a storage device, a computer, a server, etc., and the computing apparatus 100 may access the catalog of scripts 140 either directly or over a network connection. According to an example, the computing apparatus 100 is also to provide access to the catalog of scripts 140 to a plurality of electronic devices 230.1-230.n, in which the variable “n” denotes an integer greater than one. The electronic devices 230.1-230.n may be any of, for instance, laptop computers, tablet computers, personal digital assistants, cellular telephones, desktop computers, etc. Thus, for instance, a user may communicate with the script determining apparatus 102 in the computing apparatus 100 to determine candidate scripts that are to perform a requested service.

According to an example, the computing apparatus 100 facilitates access to the catalog of scripts 140, for instance, to facilitate the determination or identification of scripts in the catalog of scripts 140 that may perform a requested operation. For instance, the computing apparatus 100 may provide an interface that may be displayed graphically on respective displays 232 of the electronic devices 230.1-230.n. In addition, users may provide inputs such as desired input data, desired output data, schema of a desired input, schema of a desired output, etc., through respective input devices 234, which may be keyboards, mice, touchscreens, etc., of the electronic devices 230.1-230.n. In one regard, therefore, through use of the computing apparatus 100 disclosed herein, users may discover scripts, either individually or in combination with other scripts, in the catalog of scripts 140 that are able to perform a requested operation.

According to an example, the catalog of scripts 140 is stored on the computing apparatus 100 and the electronic devices 230.1-230.n may access the catalog of scripts 140 through the computing apparatus 100. In another example, the computing apparatus 100 may store the catalog of scripts 140 on a database accessible by the electronic devices 230.1-230.n through a server via the network 220. In either example, the network 220 may be any of the Internet, a local area network, a wide area network, a cellular network, etc. By way of example, the computing apparatus 100 may provide a webpage that is displayed on the respective displays 232 of the electronic devices 230.1-230.n.

As discussed in greater detail herein, the computing apparatus 100 may also compute respective scores for the candidate scripts based upon a number of factors such that the users may determine which of the candidate scripts may be most suitable or desirable for them in performing their requested operations. As further discussed in greater detail herein, users may provide indications as to which of the factors are of greater importance to them and the scores may be calculated based upon the importance (or weights) assigned to the factors. By way of example, the factors may be weighted according to the assigned importance of the factors.

Turning now to FIG. 3, there is shown a flow diagram of a method 300 for determining candidate scripts from a catalog of scripts 140 to perform a requested operation, according to an example. It should be apparent to those of ordinary skill in the art that the method 300 represents a generalized illustration and that other operations may be added or existing operations may be removed, modified, or rearranged without departing from a scope of the method 300. Although particular reference is made to the computing apparatus 100 depicted in FIGS. 1 and 2 as being an apparatus that may implement the operations described in the method 300, it should be understood that the method 300 may be performed in differently configured apparatuses without departing from a scope of the method 300.

At block 302, a request for an operation may be received, in which the request includes an input and an output. For instance, the input module 104 may receive a requested input and a requested output from a user through an electronic device 230.1. The requested input and the requested output may each include example data, schemas, or both. By way of particular example, the requested input may be a name and social security number of a person and the requested output may be an address of the person. As another example, the requested input may include three fields, such as a name field, an address field, and a telephone number field and the requested output may include a salary field. As another particular example, the requested input may be an image and the requested output may be a thumbnail or other modified version of the image. In any regard, and as discussed in greater detail below, the received request may be processed in various manners to facilitate discovery of scripts that are suitable for use in performing the requested operation.

At block 304, a plurality of candidate scripts that may perform the requested operation are identified from the catalog of scripts 140. For instance, the candidate script identifying module 108 may determine which of the scripts in the catalog of scripts 140 have input schemas that are compatible with the requested input schema and output schemas that are compatible with the requested output. One way to be compatible is if the schemas exactly match. Another way is if the schemas are isomorphic, that is they have the same types in the same order but not the same names, for example the schemas {name:chararray, bornIn:integer} and {person:chararray, yearsOfService:integer} are isomorphic since they both have a first value that is a chararray and a second which is an integer. Yet another way is if the schemas may be transformed so that they are isomorphic, for example the schemas {name:chararray, bornIn:integer} and {yearsOfService:integer, person:chararray} may be transformed by reordering the parameters. Another way is if the input schemas are subsets of the requested input schema and output schemas are supersets of the requested output. That is, the candidate script identifying module 108 may identify scripts having input schemas that require fewer parameters as compared with the requested input schema and/or output schemas that contain an additional field as compared with the requested output schema. A quality of match may further be computed between the schemas, for example by assigning a score to each editing operation, and finding the minimum sequence of editing operations to transform one schema into another, and then summing the scores for each of the operations in that minimum sequence. For example, if the desired output schema is {name:chararray, bornIn:integer} then the highest quality of match is {name:chararray, bornIn:integer}, a lower quality is {person:chararray, yearsOfService:integer}, and yet lower is {person:chararray, birthDate:date, yearsOfService:integer}.

According to an example in which the request for the operation includes input data and output data, the candidate script identifying module 108 may apply heuristics, e.g., rules, on the input data and output data to determine the requested input schema and the requested output schema. By way of example, the data types of the input data and the output data may be determined. Thus, for instance, in an example in which the input data and/or output data is composed of a string of characters, the string of characters may be used to determine the type of schemas that are to be retrieved from the catalog of scripts 140. In addition, extraction intelligence may be used to determine the appearance of the data. The extraction intelligence may also use previous interactions of users to determine the types of requested schemas. For example, based on similar input and output schemas that the users have provided in the past when they were searching in the catalog of scripts 140, the most likely schema that the user would select given the same or similar input and output may be learned.

The determined input schema and the requested output schema may be presented to the user for validation prior to identification of the candidate scripts. In another example in which the request for the operation includes only input schema and output schema, a suggestion to the user may be made to provide example data. The user may be assisted in entering the example data through an interface that may include pre-populated forms using the schema and/or by selecting from example data, for instance, a set of example images.

The candidate script identifying module 108 may also determine combinations of scripts in the catalog of scripts 140 having input schemas that are compatible with the requested input schema and output schemas that are compatible with the requested output. That is, the candidate script identifying module 108 may identify a set of scripts in which a first script has an input schema that is compatible with the requested input schema but whose output schema is not compatible with the requested output schema. The candidate script identifying module 108 may also identify a second script having an input schema that is compatible with the output schema of the first script and an output schema that is compatible with the requested output schema. The candidate script identifying module 108 may further identify combinations of scripts having more than two scripts that, when combined, may perform a requested operation.

According to an example in which the user has provided input and output data, each of a plurality of scripts may be run on the input data and the script outputs of each of the plurality of scripts may be determined. Thus, for instance, the input data may be run on a subset of the scripts contained in the plurality of scripts that have input schemas that compatible with the schema of the input data. In addition, a level of match of each of the script outputs with respect to the output data may be determined, in which the level of match identifies the completeness of the match. By way of example in which the output data is text data, the output data may be serialized and an edit distance measure may be used to compare the script outputs to the output data. In another example in which the output data is image data, a difference between histograms of the output data and the script outputs may be compared. In cases where either automated comparison is impractical, or the user simply prefers manual inspection, the different outputs may be presented directly to the users. Moreover, the plurality of candidate scripts may be identified from the plurality of scripts based upon the level of match of the script outputs to the output data and/or user input.

According to an example, the number of possible combinations of scripts may be limited to a predetermined number, such as two or three scripts, to substantially limit the amount of time and processing required to identify the candidate scripts. The number of possible combinations may be user-defined, set by an administrator, based upon bandwidth considerations, etc.

According to an example, the candidate script identifying module 108 may identify a filtered set of the scripts in the catalog of scripts 140 from which to identify the candidate scripts. The filtered set of the scripts may include, for instance, only those scripts having input schemas that are compatible with the requested input schema. The filtering may further limit the candidate scripts using additional information in the request for operation. For example, scripts written by a particular author, scripts whose descriptions contain a particular phrase, or scripts whose schemas have a quality of match exceeding a desired level.

At block 306, a score for each of the plurality of candidate scripts identified at block 304 may be calculated based upon a plurality of factors respectively corresponding to the plurality of candidate scripts. For instance, the score calculating module 110 may calculate a score for each of the plurality of candidate scripts to provide the user with the ability to relatively objectively compare the candidate scripts with each other. The factors may include, for instance, a quality of match between the candidate script schemas and the requested schemas, a degree of match between the candidate script output and the requested output, a runtime of the candidate script, a complexity of the candidate script composed of a single script, a complexity of a candidate script composed of a combination of scripts, a runtime of the candidate script, a popularity of the candidate script, a popularity of the component parts of the candidate script, a popularity of the candidate script when viewed by other users that have previous requested the operation, a cost associated with running the candidate script, etc. The values of the factors for each of the candidate scripts may be determined in any suitable manner and may have previously be calculated and stored, for instance, in the data store 134.

By way of example, the popularity of the candidate script and/or its components may be determined based upon a tracking of the use of the candidate scripts and/or its components by a number of users. Users may also provide ratings for the candidate scripts and/or its components and the popularity of the candidate scripts and/or its components may additionally or alternatively be determined based upon the user-provided ratings. Thus, for instance, scripts that have been used by a relatively large number of users to perform similar operations may have relatively higher values than other scripts that have been used less frequently.

The cost associated with running the candidate script may be calculated based upon, for instance, the complexity of the calculations performed by the candidate script. By way of example, the cost may be calculated based on the amount of CPU minutes the candidate script required, the monetary cost charged by a provider in running the candidate script, etc.

According to an example, the scores of the candidate scripts may be calculated by applying a function to the values of the plurality of factors. Thus, for instance, the scores may be calculated by aggregating the values of the factors together for each of the candidate scripts. In one example, the factors may be weighted such that some of the factors have greater effect on the final score. In this example, the user may specify an importance assigned to at least one of the factors with respect to the other factors, which may be used to weight the factors differently with respect to each other. Thus, for instance, a user may specify that the cost of running a script is of greater importance than the popularity of the script or vice versa. In addition, the user may specify the relative importance of the factors through a graphical interface that may include, for instance, sliders that the user may manipulate to indicate the importance of the factors. By way of example, the scores for the plurality of candidate scripts may be recalculated as the user varies the degree of importance the user has assigned to the factors.

At block 308, the plurality of candidate scripts and the calculated scores may be outputted. Thus, for instance, the outputting module 114 may output the candidate scripts and the calculated scores to be displayed on the display 232 of a user's electronic device 230.1 over the network 220. The candidate scripts may be displayed in a hierarchical arrangement (ranked order) with the candidate scripts having the highest scores positioned at the top of the hierarchical arrangement. In addition, if the scores are changed, for instance, in response to changes in the importance assigned to the factors, the ordering of the outputted candidate scripts may also be changed to maintain the outputting of the candidate scripts in the hierarchical arrangement.

Turning now to FIG. 4, there is shown a flow diagram of a method 400 for determining candidate scripts from a catalog of scripts 140 to perform a requested operation, according to another example. It should be apparent to those of ordinary skill in the art that the method 400 represents a generalized illustration and that other operations may be added or existing operations may be removed, modified, or rearranged without departing from a scope of the method 400. Although particular reference is made to the computing apparatus 100 depicted in FIGS. 1 and 2 as being an apparatus that may implement the operations described in the method 400, it should be understood that the method 400 may be performed in differently configured apparatuses without departing from a scope of the method 400.

At block 402, an interface may be provided. For instance, a user may access the interface module 106 through the network 220, such as through the Internet, and the interface module 106 may cause the interface to be displayed on a display 232 of the user's electronic device 230.1. The interface may be a webpage or other portal through which users may discover the scripts contained in the catalog of scripts 140. By way of example, the interface module 106 may display a graphical user interface on the display 232 of a user's electronic device 230.1 and may provide the user with various options with respect to the determination of at least one script to perform a requested operation from a catalog of scripts 140. The graphical user interface may include fields into which a user may identify input data, input schemas, output data, output schemas, etc. The graphical user interface may also include fields into which a user may define the relative importance of various factors with respect to other factors. In any regard, the graphical user interface may include various drop-down menus and/or input locations to guide users in the inputting of requests for operations and may also include drop-down menus, sliders, etc., through which users may indicate their preferences with regard to the calculations of the scores corresponding to the candidate scripts that may perform the requested operations.

At block 404, a request for an operation may be received, in which the request includes an input and an output. The request for the operation may be received through the interface provided at block 402 in any of the manners discussed above with respect to block 302. In addition, at block 406, the request for the operation may be processed, for instance, to determine the input schema and the output schema of the request as also discussed above with respect to block 302. Moreover, at block 408, a plurality of candidate scripts that may perform the requested operation are identified from the catalog of scripts 140 as discussed above with respect to block 304.

At block 410, an indication of the relative importance of a factor of the plurality of factors may be received. As also discussed above with respect to block 306, a user may assign different importance levels to the factors of the candidate scripts and the different important levels may be used to assign respective weights to the factors, which may cause the candidate scripts to have different scores. In addition, the scores of the candidate scripts may vary depending upon the importance levels assigned to the various factors.

At block 412, a score for each of the plurality of candidate scripts may be calculated based upon a plurality of factors respectively corresponding to the plurality of candidate scripts as discussed above with respect to block 306. In addition, the scores may be calculated based upon the respective weights assigned to the factors.

At block 414, the plurality of candidate scripts and the calculated scores may be outputted in a hierarchical arrangement according to the scores of the candidate scripts. Thus, for instance, the candidate scripts may be displayed on the display 232 of a user's electronic device 230.1 in a hierarchical arrangement in which the candidate scripts that may be most desirable to a user may be displayed first.

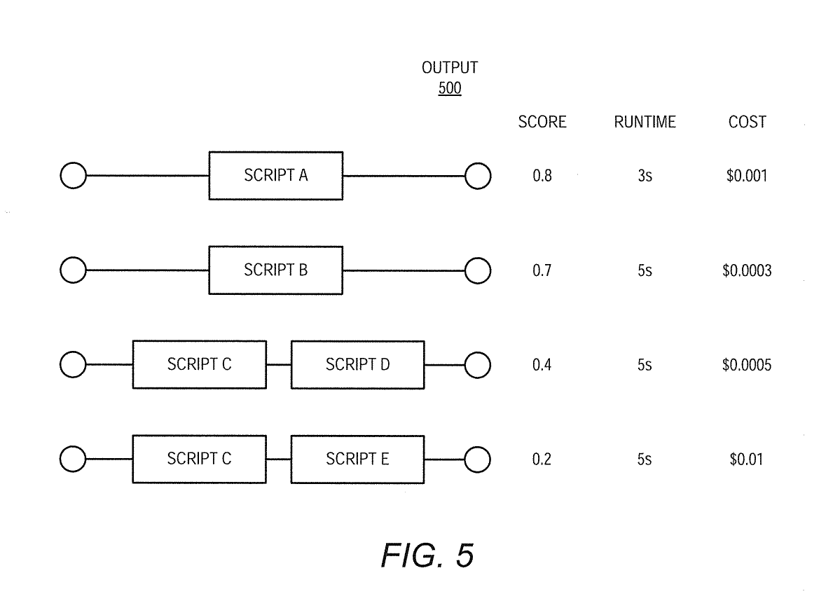

A simplified example of an output 500 of a plurality of candidate scripts and the calculated scores are shown in FIG. 5. Particularly, candidate scripts A-E are shown therein along with their respective scores, runtimes, and costs. As such, in addition to the respective scores, additional factors may be displayed with the candidate scripts A-E. A user may thus select one of the candidate scripts to perform a particular operation based upon the factors displayed in the output 500.

Although not shown in FIGS. 3 and 4, the methods 300 and 400 may include receipt of a selection of a candidate script to perform the requested operation. The selection of the candidate script may be stored and may be used in, for instance, determining the popularity of the selected script. In addition, the selected candidate script may be run to perform the user's requested operation.

Some or all of the operations set forth in the methods 300 and 400 may be contained as a utility, program, or subprogram, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

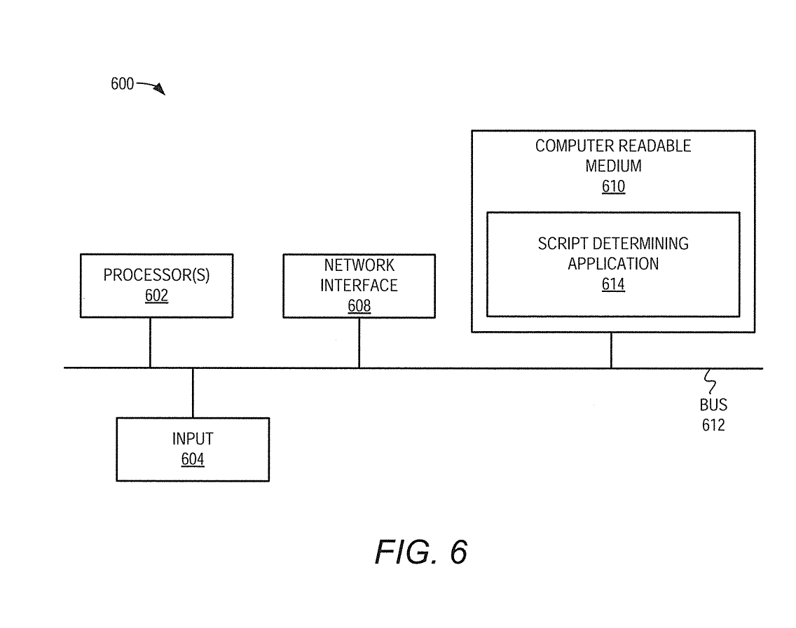

Turning now to FIG. 6, there is shown a schematic representation of an electronic device 600, which may be employed to perform various functions of the computing apparatus 100 depicted in FIGS. 1 and 2, according to an example. The device 600 may include a processor 602, an input 604; a network interface 608, such as a Local Area Network LAN, a wireless 802.11x LAN, a 3G mobile WAN or a WiMax WAN; and a computer-readable medium 610. Each of these components may be operatively coupled to a bus 612.

The computer readable medium 610 may be any suitable medium that participates in providing instructions to the processor 602 for execution. For example, the computer readable medium 610 may be non-volatile media, such as an optical or a magnetic disk; volatile media, such as memory. The computer-readable medium 610 may also store a script determining application 614, which may perform the methods 300 and 400 and may include the modules of the script determining apparatus 102 depicted in FIG. 1. In this regard, the script determining application 614 may include an input module 104, an interface module 106, a candidate script identifying module 108, a score calculating module 110, a hierarchical arrangement managing module 112, and an outputting module 114.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for determining candidate scripts from a catalog of scripts to perform a requested operation, said method comprising:
receiving a request for an operation, wherein the request includes an input and an output;
identifying, based upon the input and the output, a plurality of candidate scripts that are to perform the requested operation from the catalog of scripts, wherein each of the plurality of candidate scripts comprises at least one of a script that is to perform the requested operation individually or a number of scripts that, in combination, are to perform the requested operation;
calculating, by a processor, a score for each of plurality of candidate scripts based upon a plurality of factors respectively corresponding to the plurality of candidate scripts; and
outputting the plurality of candidate scripts and the calculated scores.

2. The method according to claim 1, further comprising:
accessing an input schema of the input and an output schema of the output; and
wherein identifying the plurality of candidate scripts further comprises identifying a candidate script from the catalog of scripts having the input schema and the output schema.

3. The method according to claim 1, further comprising:
accessing an input schema of the input and an output schema of the output; and
wherein identifying the plurality of candidate scripts further comprises identifying a first script having the input schema and a second script having the output schema, wherein the second script has a script input schema that is compatible with a script output schema of the first script.

4. The method according to claim 1, wherein receiving the request for an operation further comprises receiving an input data and an output data, and wherein identifying further comprises:
running each of a plurality of scripts on the input data;
determining script outputs of each of the plurality of scripts;
determining a level of match of each of the script outputs with the output data; and
identifying the plurality of candidate scripts from the plurality of scripts based upon the level of match of the script outputs with the output data.

5. The method according to claim 1, wherein calculating the score further comprises calculating the scores for each of the plurality of candidate scripts based upon at least two of a degree of match between the candidate script output and the requested output, a runtime of the candidate script, a complexity of the candidate script composed of a single script, a complexity of a candidate script composed of a combination of scripts, a runtime of the candidate script, a popularity of the candidate script, a popularity of the component ports of the candidate script, a popularity of the candidate script when viewed by other users that have previous requested the operation, and a cost associated with running the candidate script.

6. The method according to claim 1, wherein outputting the plurality of candidate scripts and the calculated scores further comprises outputting the plurality of candidate scripts in a ranked order based upon the calculated scores.

7. The method according to claim 6, further comprising:
receiving an indication as to an importance of a factor in the plurality of factors; and
wherein outputting the plurality of candidate scripts in the ranked order further comprises outputting the plurality of candidate scripts in the ranked order such that the factor indicated as having a higher importance is displayed higher in the ranked order.

8. The method according to claim 1, wherein identifying the plurality of candidate scripts further comprises identifying the plurality of candidate scripts from a filtered set of the scripts contained in the catalog of scripts.

9. An apparatus to determine candidate scripts from a catalog of scripts to perform a requested operation, said apparatus comprising:
a processor;
a memory on which is stored machine readable instructions that cause the processor to:
receive a request for an operation, wherein the request includes an input and an output;
identify, based upon the input and the output, whether the catalog of scripts includes an individual script that is to perform the requested operation;
identify, based upon the input and the output, whether the catalog of scripts includes a combination of scripts that is to perform the requested operation;
calculate a score for each of the identified scripts based upon a plurality of factors respectively corresponding to the plurality of identified scripts; and
output the plurality of identified scripts and the calculated scores, wherein the plurality of identified scripts are the candidate scripts.

10. The apparatus according to claim 9, wherein the machine readable instructions further cause the processor to:
access an input schema of the input and an output schema of the output;
identify a candidate script from the catalog of scripts having the input schema and the output schema; and
identify a first script having the input schema and a second script having the output schema, wherein the second script has a script input schema that is compatible with a script output schema of the first script.

11. The apparatus according to claim 9, wherein the machine readable instructions further cause the processor to:
output the plurality of candidate scripts in a ranked order based upon the to calculated scores.

12. The apparatus according to claim 9, wherein the machine readable instructions further cause the processor to:
receive an indication as to an importance of a factor in the plurality of factors; and
output the plurality of candidate scripts in the ranked order such that the factor indicated as having a higher importance is displayed higher in the ranked order.

13. A non-transitory computer readable storage medium on which is stored machine readable instructions that when executed by a processor are to cause the processor to:
receive a request for an operation, wherein the request includes an input and an output;
identify, based upon the input and the output, a plurality of candidate scripts that are to perform the requested operation from the catalog of scripts, wherein each of the plurality of candidate scripts comprises at least one of a script that is to perform the requested operation individually or a number of scripts that, in combination, are to perform the requested operation;
calculate a score for each of plurality of candidate scripts based upon a plurality of factors respectively corresponding to the plurality of candidate scripts; and
output the plurality of candidate scripts and the calculated scores.

14. The non-transitory computer readable storage medium according to claim 13, wherein the machine readable instructions are further to cause the processor to:
access an input schema of the input and an output schema of the output;
identify a candidate script from the catalog of scripts having the input schema and the output schema; and
identify a first script having the input schema and a second script having the output schema, wherein the second script has a script input schema that is compatible with a script output schema of the first script.

15. The non-transitory computer readable storage medium according to claim 13, wherein the machine readable instructions are further to cause the processor to:
receive an indication as to an importance of a factor in the plurality of factors; and
output the plurality of candidate scripts in the ranked order such that the factor indicated as having a higher importance is displayed higher in the ranked order.
